(19) United States
(12) Patent Application Publication
(10) Pub. No.: US 2018/0091629 A1
(43) Pub. Date: Mar. 29, 2018

(54) VIRTUAL AND AUGMENTED REALITY INTERFACE

(71) Applicant: Emblematic Group, Inc., Santa Monica, CA (US)

(72) Inventor: Nonny de la Pena, Santa Monica, CA (US)

(21) Appl. No.: 15/721,676

(22) Filed: Sep. 29, 2017

Related U.S. Application Data
(60) Provisional application No. 62/401,715, filed on Sep. 29, 2016.

(51) Int. Cl. H04L 29/06; H04L 29/08; G06F 3/0481; G06F 3/0482; G06F 3/16; G06F 3/01

(52) U.S. Cl. CPC H04L 67/38; H04L 67/025; G06F 3/013; G06F 3/0482; G06F 3/167; G06F 3/04817

(57) ABSTRACT

Systems and methods for providing a Virtual Reality (VR) platform for users to browse, explore, and launch such VR content are disclosed herein. In one embodiment, the system includes a backend network comprising a server in communication with one or more databases and a storage system housing VR media content. The backend network presents a VR platform populated with VR content presented in its fully-dimensionalized form. The system includes a user VR system in communication with the backend network. The VR system presents the VR platform to the user in a fully-dimensionalized form. The system includes a web portal in communication with the backend network, wherein a third-party developer may upload VR content to the storage system. The system includes a software component downloaded to a developer computer, wherein the software component obtains the preview from the developer computer to be used on the virtual reality platform.

### CROSS-REFERENCE TO RELATED APPLICATIONS

The present application claims the benefit of U.S. Provisional Patent Application Ser. No. 62/401,715 filed on Sep. 29, 2016, the entire disclosure of which is incorporated herein in its entirety by reference.

### FIELD

This disclosure generally relates to systems and methods allowing users to navigate and interact with virtual or augmented reality content.

### BACKGROUND

Virtual Reality (VR) generally refers to a computer-generated, three-dimensional environment that allows a person to experience, explore and interact with this environment with specialized equipment. With a wide variety of VR content being created on different software platforms, traditional user interfaces (composed of a plurality of windows/boxes showing a two-dimensional images and videos of the VR content) are ill-suited to allow a person to quickly navigate and preview the VR content. Two-dimensional images and videos are, by their very nature, incapable of accurately conveying to the user the sensation of being present in a fully dimensionalized, volumetric experience.

### SUMMARY

Systems and methods for providing a Virtual Reality (VR) platform for users to browse, explore, and launch such VR content are disclosed herein. In one embodiment, the system includes a backend network comprising a server in communication with one or more databases and a storage system housing VR media content. The backend network presents a VR platform populated with VR content presented in its fully-dimensionalized form. The system includes a user VR system in communication with the backend network. The VR system presents the VR platform to the user in a fully-dimensionalized form. The system includes a web portal in communication with the backend network, wherein a third-party developer may upload VR content to the storage system. The system includes a software component downloaded to a developer computer, wherein the software component obtains the preview from the developer computer to be used on the virtual reality platform.

### BRIEF DESCRIPTION OF THE DRAWINGS

FIG. 1 illustrates one embodiment of the Virtual Reality (VR) and Augmented Reality (AR) platform.

FIG. 2A illustrates one embodiment of the frontend system of the VR platform.

FIG. 2B illustrates one embodiment of the backend system of the VR platform.

FIG. 2C illustrates one embodiment of the backend system of the VR platform.

FIG. 3 illustrates a one embodiment of the Virtual Reality (VR) platform showing the user experience (UX) of the VR platform.

FIG. 4 illustrates various embodiments of user VR input devices for the VR.

FIG. 5 illustrates one embodiment of the Virtual Reality (VR) platform.

FIG. 6 illustrates one embodiment of a user interacting with the Virtual Reality (VR) platform.

FIG. 7 illustrates one embodiment of the Virtual Reality (VR) platform showing how the platform can be populated with multiple users.

FIG. 8A illustrates how the user can select to launch a VR experience in one embodiment of the Virtual Reality (VR) platform.

FIG. 8B illustrates how the selected trailer begins to transform into the full experience in one embodiment of the Virtual Reality (VR) platform.

FIG. 8C illustrates how the selected trailer transforms into the full experience in one embodiment of the Virtual Reality (VR) platform

FIG. 9A illustrates one embodiment of how the multiple users can watch and experience the trailer platform together in one embodiment of the Virtual Reality (VR) platform.

FIG. 9B illustrates one embodiment of how users will be able to watch and experience in one embodiment of the Virtual Reality (VR) platform.

FIG. 9C illustrates how multiple users can watch the full experience in one embodiment of the Virtual Reality (VR) platform.

FIG. 10A illustrates how a user can select through gaze, voice or controller a specific content vertical in one embodiment of the Virtual Reality (VR) platform.

FIG. 10B illustrates how the platform transforms into only being populated by the specific content vertical selected in FIG. 10A.

FIG. 11A illustrates one embodiment of the Augmented Reality (AR) platform.

FIG. 11B illustrates one embodiment of the Augmented Reality (AR) platform.

FIG. 11C illustrates one embodiment of the Augmented Reality (AR) platform.

FIG. 12A illustrates a one embodiment of the Augmented Reality (AR) platform showing the UX of the platform in which the AR snippets/trailers can placed on the ground and viewed life-sized with AR-enabled device or head mounted display. Various content verticals such as but not limited to can include news, entertainment, sports, lifestyle and technology populate each concentric circle. The circles spread upward but not downward offering users the ability to slide circles of content downward, as the ones below disappear below the visible physical world floor.

FIG. 12B illustrates a one embodiment of the Augmented Reality (AR) platform placed on the ground and showing the UX when the user chooses a snippets/trailers of interest.

FIG. 12C illustrates a one embodiment of the Augmented Reality (AR) platform placed on a ground showing the UX of the platform when the user launches and streams a specific piece of content.

### DESCRIPTION OF EMBODIMENTS

Briefly and in general terms, systems and associated methods for providing a platform and interface for developers to upload Virtual Reality (VR) content and a VR platform for users to browse, explore, and launch such VR content are disclosed herein. The VR platform is populated with VR and, in some embodiments, augmented reality (AR) content. The platform will be propagated with virtual reality and augmented reality native content which themselves may incorporate other forms of media including, but not limited to, 360° video, 2D video, and other multimedia elements. More specifically, the VR platform provides a three-dimensional, volumetric interface in which each piece of VR and AR content is presented in their native form. This VR interface provides the user with an immersive experience within the VR interface and offers fully-dimensionalized previews (i.e., the previous are provided in full 3D immersive virtual reality experience) that are representative of the actual content as compared to a flat two-dimensional display. The VR interface provides one or more methods to interact and browse through the content presented on the VR platform.

For users, a full VR experience to browse and explore VR content minimizes “sim sickness,” which is the nausea that may be induced with the movements of a virtual camera while the user's body remains relatively motionless. Additionally, the VR platform enables time-efficient and convenient browsing of VR content as the user is able to preview a number of VR experiences without constantly removing and putting on VR equipment and accessing a computer to backtrack to a main menu. The VR platform offers users a better understanding of the VR content they will engage and can potentially save them money as they can preview the actual content without having to purchase it. For developers, the VR platform eliminates the need to create two-dimensional videos or images for current browsing platforms. This minimizes any potential damage to the developer's reputation and saves the developer from contending with disappointed customers who may feel misled by the two-dimensional video clips.

In the various embodiments disclosed herein, the VR platform uses three-dimensional models and three-dimensional space to create a VR browsing tool native to the VR medium so that end users can garner information relevant to the VR content (e.g., VR applications) in a manner that is indicative of the actual VR experience. It also offers an organized system for viewing the VR preview trailers and any associated background information and launching the VR experience should the discovered content be found of interest by the end user.

The 3D environment increases the feeling of presence within the space and provides accurate previews because the platform is built in three dimensions. The interface allows the user to rapidly explore content and experience 3D previews and/or trailers. The interface encourages the user to investigate the content and have a quick understanding of the experience the application offers.

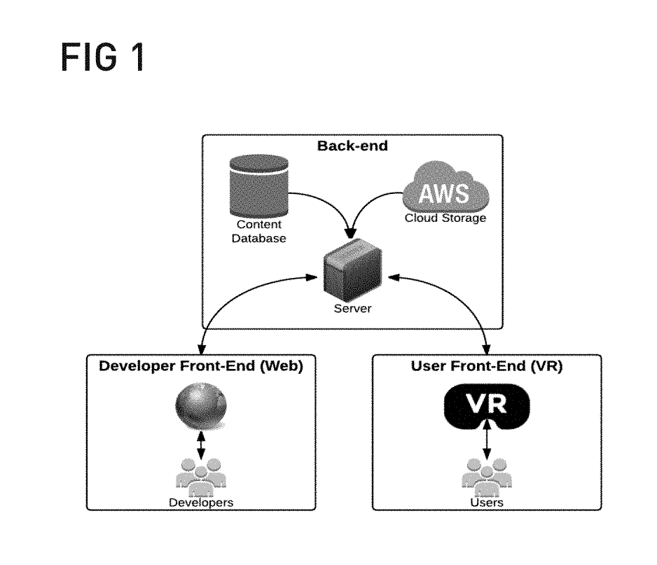

FIG. 1 illustrates one embodiment of the VR platform showing client-server system with two different front end interfaces, one interface is dedicated to developers to upload their VR content and a separate interface for users to browse, download, or view VR/AR content. As shown in FIG. 1, the back-end is composed of a content database and a cloud storage service (e.g., Amazon® Cloud-based services) in communication with one (or more) servers. The content database (e.g., MySQL database) stores data such as, but not limited to, developer account information, user account information, information about the developer content uploaded to the platform, and references to the cloud storage service. The cloud storage service holds the developer's uploaded files including, but not limited to, executables, short animation files (e.g., FBX files), 3D models relevant to the uploaded content, and any other relevant files.

As shown in FIG. 1, the platform includes a web-based portal for developers. This portal allows developers to upload their content. The web-based portal includes a plurality of webpages that allow developers to create an account, access their account, and upload content. The portal may also include one or more webpages dedicated to providing information about the VR platform, platform requirements, and instructions to upload content. The portal may also include one or more web pages soliciting information about the upload content, including, but not limited to, the title of the VR/AR experience, a brief description of the content, keyword tags identifying the themes of them content, the genre to which it belongs, such as sports, lifestyle, music, etc., and its suitability for various kinds of audience. The developer may upload the executable for the VR/AR experience along with a number of supporting files, such as animations and 3D models, that will be displayed to the end-user when browsing the content on the VR/AR platform. In another aspect of the UI, the user is able to create an account and set personal preferences for the interface. These preferences include font size, organization of content, content filters, and any other preferences known or developed in the medium.

The VR platform also includes a user front-end interface as shown in FIG. 1. The user interface is VR-based and will display the VR content uploaded by the developers. The user interface (UI) uses three-dimensional models and three-dimensional space to virtually place the user inside the UI. In one embodiment, all the available content will be displayed in 3-dimensional grid format (with content aligned and spaced along the x-, y-, and z-axes). Other configurations of the content are also contemplated such as, but not limited to, the content shown along the x- and y-axes. In another aspect of the user interface, the user is able to create an account and set any preferences for the VR interface. The preferences include font size, organization of content, content filters, and any other preferences known or developed in the art.

While FIG. 1 shows a VR platform with two different front end interfaces (one interface is dedicated to developers to upload their VR content and a separate interface for users to browse, download, or view VR content), the VR platform may have a single user interface (not shown) for both developers and users.

As shown in FIG. 1, the VR platform is presented to the user as a cylindrical interface in which the user is in the center of the cylinder. There are concentric rings of VR icons above the user's line of sight, in front of the user, and below the user's line of sight. In FIG. 1, the VR icons are organized according to one of a plurality of VR content categories such as, but not limited to, sports, entertainment, lifestyle, news, or technology. In an alternate embodiment, the VR platform (not shown) is only composed of VR content in a single genre or content-type.

In one embodiment, the VR icons are made up of 3-dimensional FBXs with embedded animations. These embedded animations act as a preview or trailer of the larger piece of VR content that may be launched.

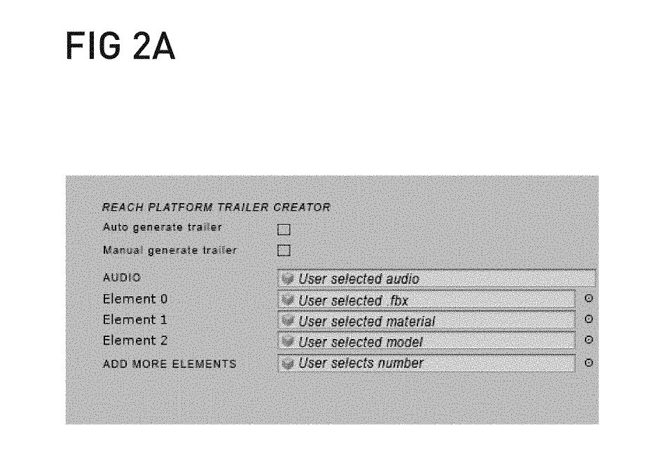

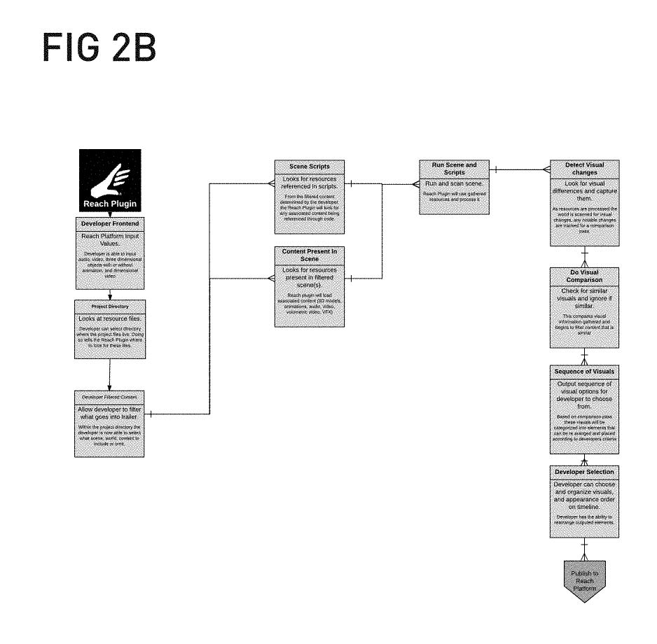

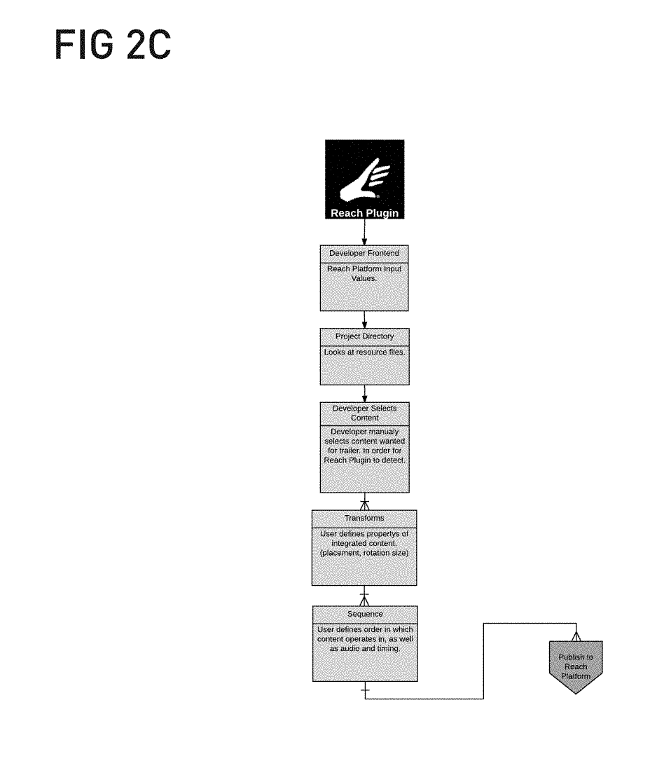

FIG. 2A illustrates a trailer generator plug-in. The plug-in is software that is resident on the developer's computer. The plugin provides a means for developers to derive from existing VR or AR projects or scenes a snippet from those projects or scenes that will be displayed as trailer scene. The plug-in is compatible with multiple development platforms, game engines and 3D modeling sculpting and texture programs such as but not limited to 3D-Coat, 3ds Max, Blender, Character Creator, Cinema 4D. Cubik Studio, Earth Volumetric Studio. Easy Cube. Form Z. Grasshopper, Codon. Lightware, Maya, Meshlab, Modo, Adobe Photoshop, Polybrush. Qubicle. Simlab Composer. Sketchup, Strata Design 3D. Substance Painter, ZBrush, Unity and Unreal, that is capable of identifying all the files and attributes necessary to create a scene to populate the trailer structure. These materials include, but are not limited to FBXs with embedded animations, textures, models, and any other necessary files or attributes. The plug-in features a simple interface with check boxes that allow developers to rapidly select which pieces in an interface offering a public variable system for selecting the files they wish to upload to the platform. This public variable is part of the algorithm that creates functionality within development platforms in order to simplify the process by offering simple check boxes and/or sliders to select items such as but not limited to models, textures, fbx files and/or other elements necessary to create a sample scene of the full project that will ultimately be uploaded onto the platform as an executable. This plugin will be deployed within the development software and lets the user make a selection between auto-generating a trailer from a scene or manually inputting elements that would make the trailer. The trailer or resulting snippet will then be uploaded onto the platform. The trailer will then reside on the platform as representative of what a user might experience should they choose to stream a full experience. As shown in FIG. 2A, the interface allows developers to choose whether they wish to auto generate or manually select elements that form the snippet of a scene that will then populate the platform.

FIG. 2B illustrates one embodiment of the backend system of the VR platform. As shown in FIG. 2B shows a flow chart in which a software component on the VR system (also referred to as a “plugin”) which provides a means for developers if they choose to auto-generate a snippet from a scene that will then populate the VR platform. The snippet will then act as trailers to represent what a user might experience should they choose to stream a full experience.

As shown in FIG. 2B and described below, by selecting the box to auto generate a trailer, the plugin will review and select the necessary files to create a trailer. The plugin will select from a scene or project that the developer has already created the appropriate files necessary to create the trailer, including but not limited to selection of an audio file, texture files, materials files, models, and animation files. The plugin will then compile elements into the trailer. The developer has the option to review, edit, or revise the trailer before it is uploaded to the VR platform. In an alternate embodiment, the auto generated trailer is presented to the developer and the developer can only select a portion of the auto generated trailer for upload to the VR platform. In yet another alternative, the developer can cancel the auto trailer and have a new trailer created. If the manual generator trailer is selected, the developer needs to select the necessary files that will be compiled to form the trailer. The files that the developer may select from include at a minimum, but are not limited to selection of an audio file, texture files, materials files, models, and animation files. The plugin allows users to add additional elements that are necessary for the generation of the trailer. The plugin will then compile all elements and export the trailer.

The plugin works through a hierarchy of selection where the developer has the ability to tell the plugin what file directory to look in. Once the directory is created the developer is able to input audio, video, three dimensional objects, rigs, animation, visual effects, and volumetric video. Once the scene and content has been filtered the Reach plugin will look into the available scenes or worlds and gather said content for the trailer creation. A separate script pass will look for and gather any associated content referenced through code. Once all necessary resources have been gathered the scene will be simulated and the Reach plugin will scan the world for visual changes. The visual changes that are captured in clusters and are categorized into multiple elements. Once elements are captured the developer will be able to rearrange the order and time the elements are appearing. When the developer is ready the developer can hit publish and the trailer will be generated.

FIG. 2C illustrates one embodiment of the backend system of the VR platform. FIG. 2C shows a flow chart in which a software component provides a means for developers to manually generate a snippet from a scene that will then populate the platform. The snippet will then act as trailers to represent what a user might experience should they choose to stream a full experience.

As shown in FIG. 2C, in this embodiment the auto-selection of elements will not occur but developers will be able to review, edit, or revise the trailer before it is uploaded to the VR platform the trailer before it is uploaded to the VR platform. The plug-in uses public variables that allows the developer to choose which elements are appropriate for their trailer.

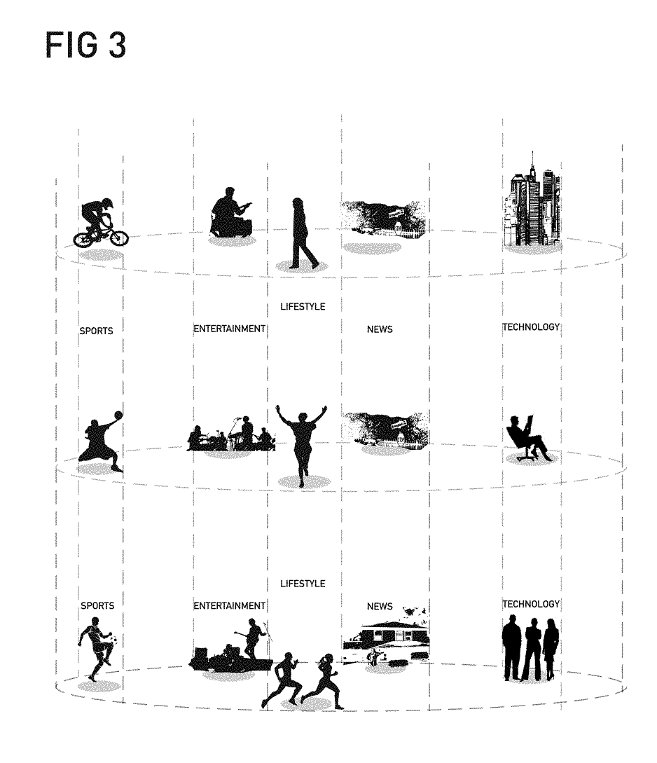

FIG. 3 illustrates a one embodiment of the Virtual Reality (VR) platform showing the UX of the platform in which VR snippets wait to be triggered by user. Various content verticals such as, but not limited to, news, entertainment, sports, lifestyle and technology populate each circle that continue upward and downward so that all trailers in the system can be explored and launched. The user can also filter through the content using different categories like sports, entertainment, news, etc. as well as view content which is related to his previous history and interests, or view trending and new content.

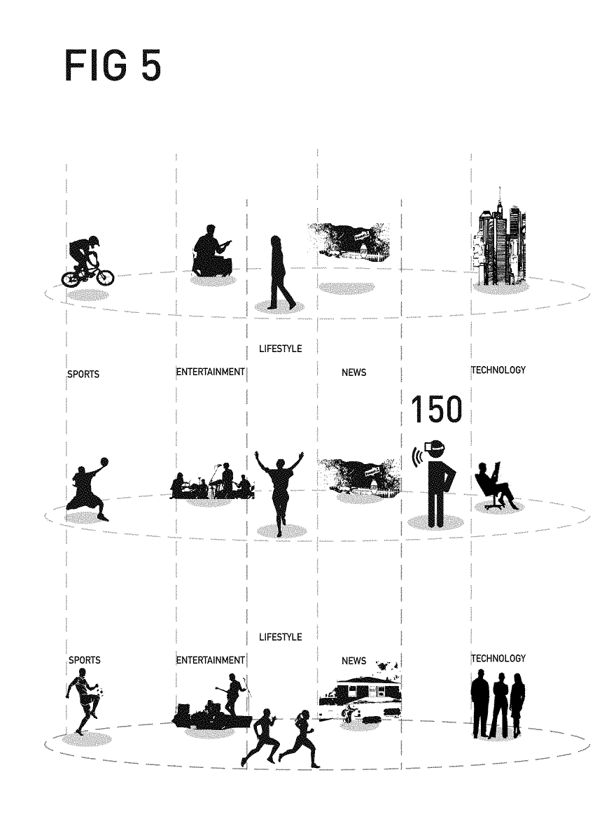

In alternate embodiments, similar content is shown horizontally. For example, the upper ring of material (not shown) would be dedicated to news, middle ring is dedicated to sports content, and lower ring is movies. In yet another embodiment, the content is grouped in quadrants in the VR platform. That is, the user is in the center of the VR platform, as illustrated in FIG. 5, and blocks of information in quadrants (not shown) above, below, left, and right of user's field of vision are groups of similar content. In another embodiment, if the user is in the center of the VR platform, as illustrated in FIG. 5, the quadrants (not shown) of information are in front, back, left and right of the user. In yet another embodiment, the user may customize the organization of the content by filtering content (removing categories) or prioritizing categories, or the like. In yet another embodiment, users may customize content so that it only their own content or the content made by particular users of interest.

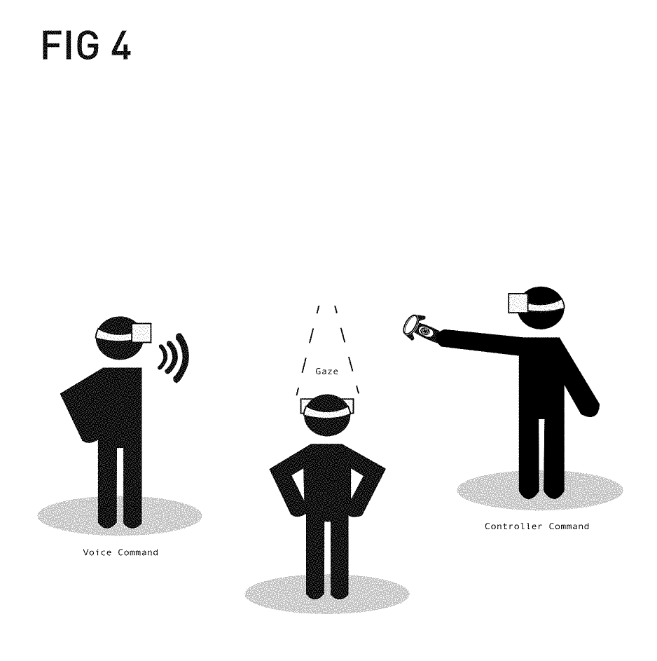

The user is able to navigate through the available content using user input device such as controllers, joysticks, voice commands, or gaze as shown in FIG. 4 and described below. The user may also interact with a virtual keyboard or other system that tracks a user's gesture, including the ability to draw text in the virtual environment that the software can understand and translate into commands.

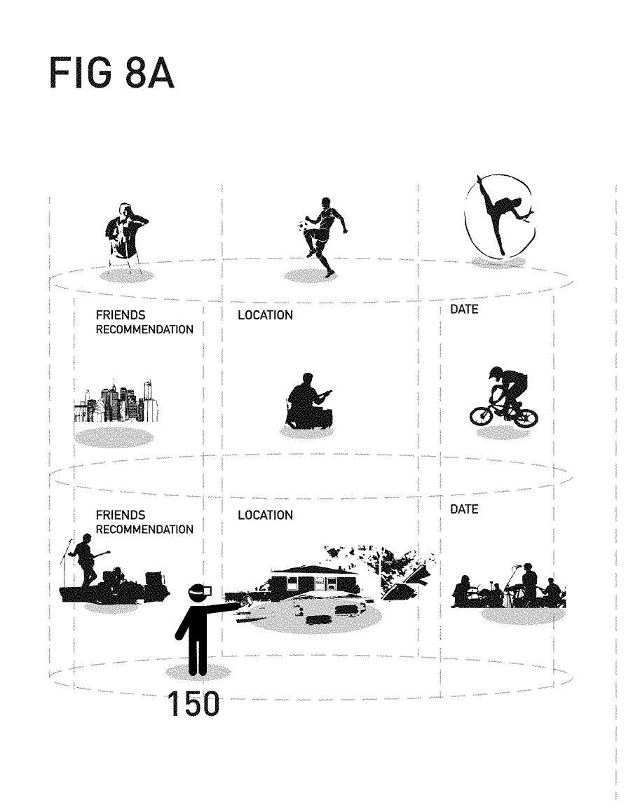

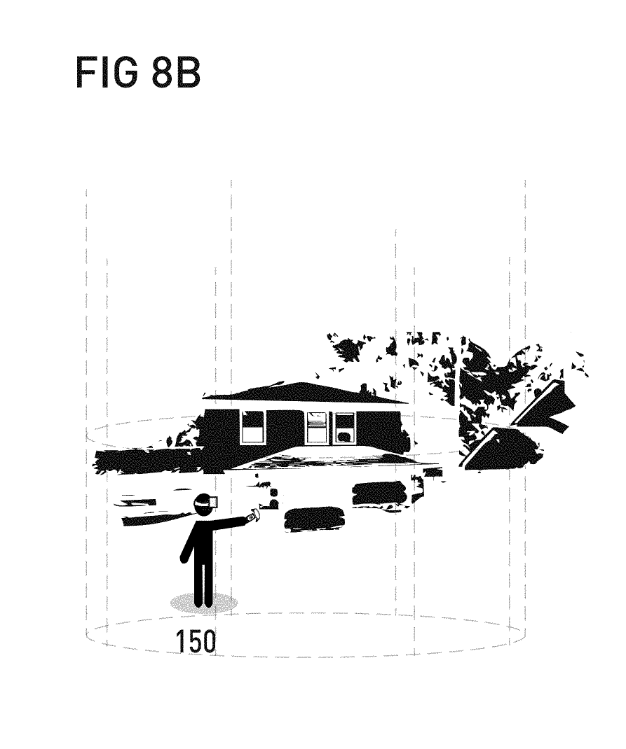

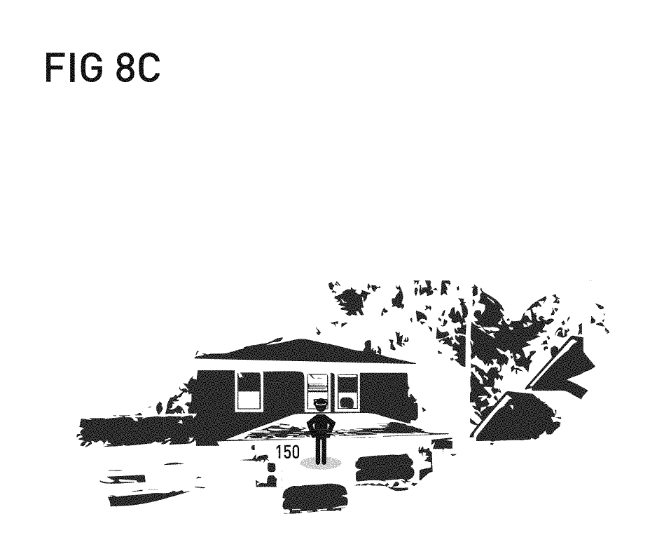

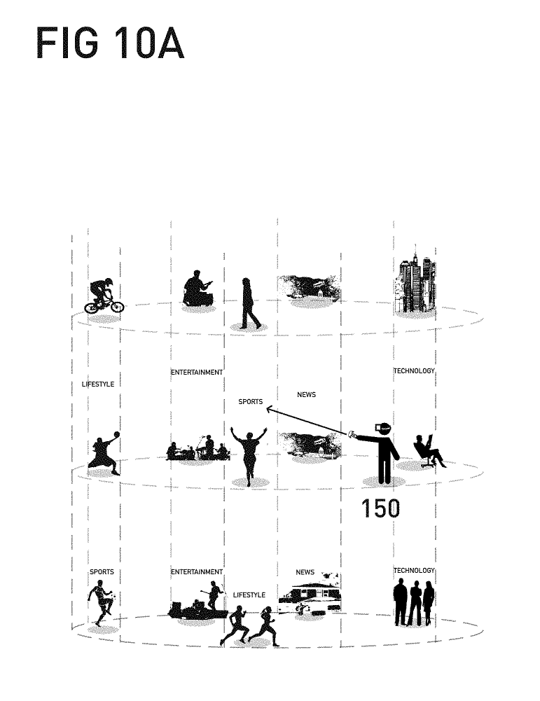

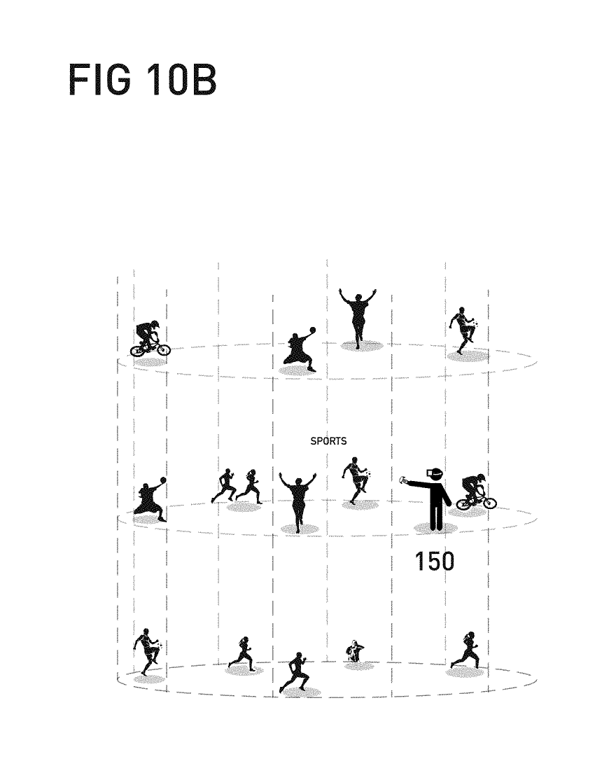

When a user selects a particular piece of content, the selected content pops into the foreground of the UI and additional information and/or details about the content is presented as shown in FIGS. 8B and 10B. The additional information can be a brief description of the content, short animation snippets, characters or events from the content, and any other information provided by the developer. The user will also have the option to run or stream the actual content, or return to browsing through content.

Additionally, as shown in FIG. 10B, the VR content in the VR platform may be repopulated to show only content from one particular genre. For example, as shown in FIG. 10A, the user selects sports genre. As shown in FIG. 10 B, all the content in the VR platform is from the sports genre. In other embodiments, the selection of a particular genre may place the selected in the main field of vision of the user and related genres may be place off to the periphery as suggestions to the user.

FIG. 4 illustrates three different embodiments for a user to interact with a VR environment. As shown in FIG. 4, a user wears VR goggles that may use gaze control, eye tracking, or head motion to manipulate content on the VR platform. By way of example and not of limitation, the user may gaze at a particular icon, and the VR content will automatically play. In FIG. 4, a headset including audio input devices such as, but not limited to, microphones may be used to communicate voice commands that manipulate the content on the VR platform. The user may state various commands to navigate, search, organize, or play VR content. As shown in FIG. 4, a handheld controller may be used as an input device for the user. As those skilled in the art will appreciate the various input devices shown in FIG. 4 may be used alone or in any combination together.

Other examples of user control devices include but are not limited to, smartphones, tablets, heads-up displays (HUDs), gaming consoles, head-mounted displays (HMDs), virtual reality goggles, augmented reality goggles, or any other device, or combination of devices, capable of communicating data and providing an interface or display to the user. In some embodiments, the user device may include, or communicate with, local peripheral or input/output components including, but not limited to, a keyboard, mouse, joystick, gaming controller, haptic interface device, motion capture controller, optical tracking device, audio equipment, voice equipment, projector system, 3D display, and holographic 3D glasses or contact lenses. Additionally, virtual digital recreations of any of these devices may be used for the same functions.

FIG. 5 illustrates one embodiment of the Virtual Reality (VR) platform. FIG. 5 shows how the VR platform and the VR snippets contained therein surrounding the user 150 in rings of VR content. That is, there are VR snippets within the user's field of vision and behind the user. Also, as shown in FIG. 5, the content is shown above the user and below the user.

The VR snippets appear to be a spaced distance from the user. In one embodiment, the perceived distance the VR snippet is presented to the user is predefined by the VR platform. In an alternate embodiment, the perceived distance may be manually selected or adjusted by the user.

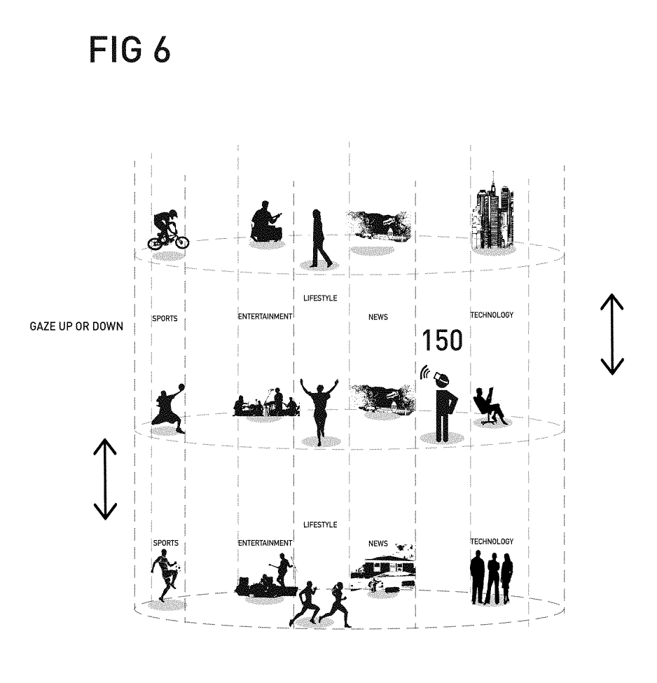

FIG. 6 illustrates one embodiment of the Virtual Reality (VR) platform showing how the platform in which the user can gaze up or down so that new trailers from the various content verticals slide onto the same x axis as the user. More specifically, the user VR interface devices (e.g., headset, controllers) and associated systems include sensors and processors that may be used to track the user's head and body position. The head and/or body position will cause a change in the view of the VR content shown to the user. In one embodiment, the upward gaze of the user causes the VR snippets to move down so that it comes into the field of vision in front of the user. Similarly, a downward gaze will cause the VR content to move up onto the same x-axis of the user.

In another embodiment, as the user turns and/or moves in the VR space, new VR content comes into the user's field of vision. In an alternate embodiment, the user can opt to manipulate the VR platform (i.e., cause content to spin relative to the user) with voice commands, user input devices, or gaze.

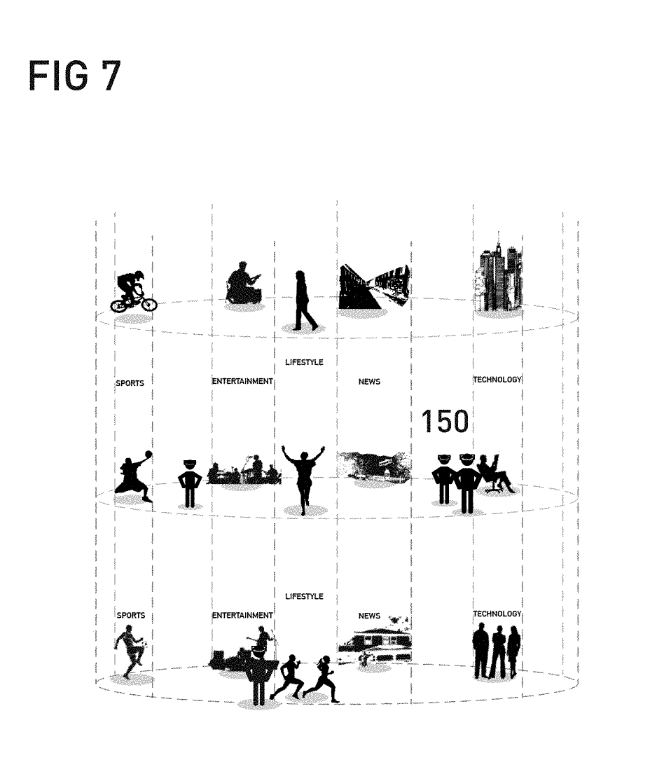

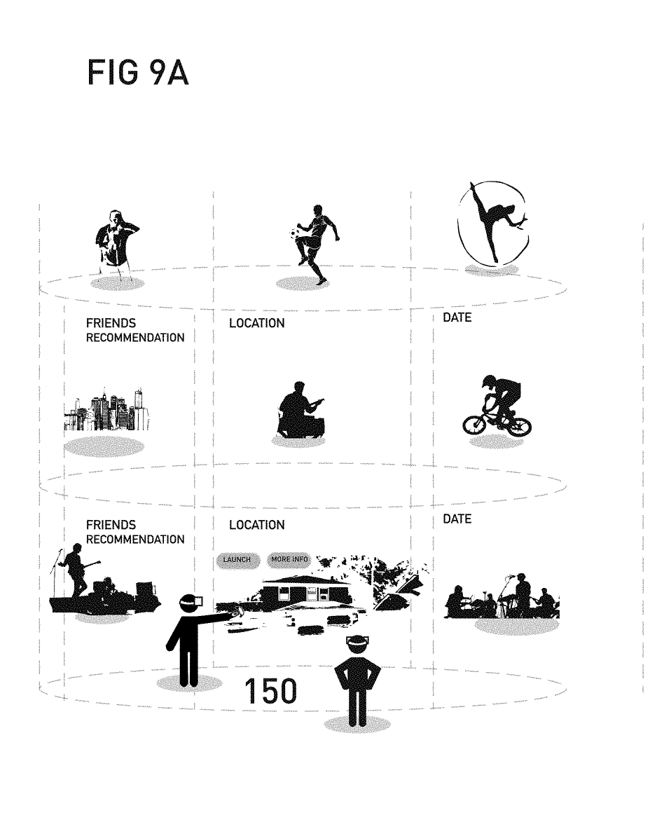

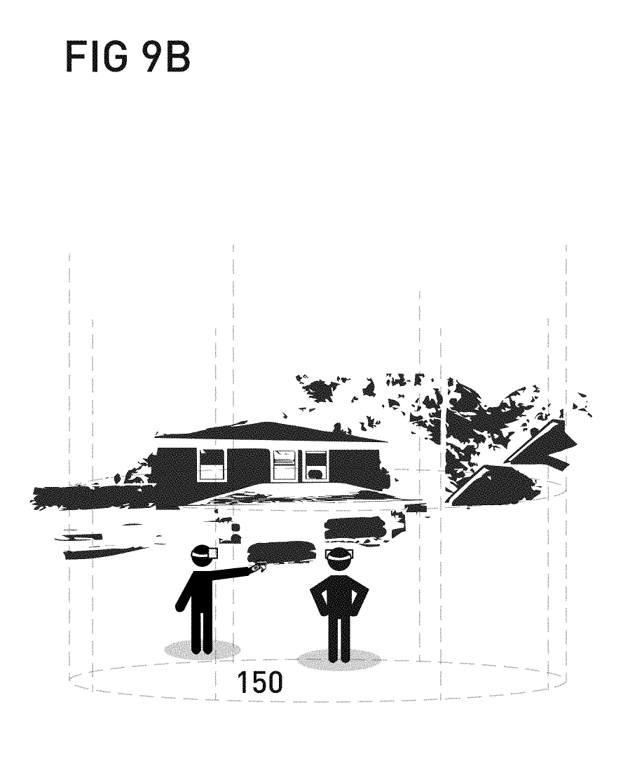

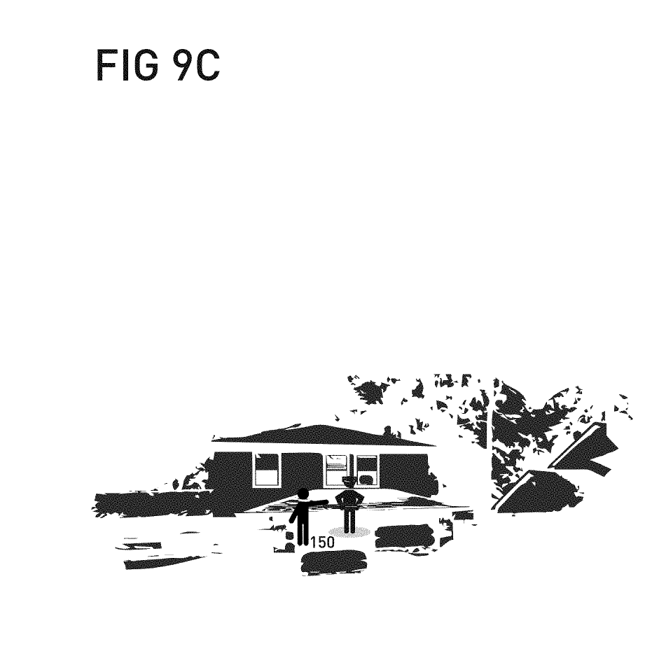

FIGS. 7, 9A-B illustrate one embodiment of the Virtual Reality (VR) platform showing how the platform can be populated with multiple users who can also engage with each other and watch synchronously as trailers are selected and streamed. In one embodiment, the system allows the user to create an avatar that will show the user in the VR platform so that the users may see one another as shown in FIGS. 7 and 9A. In another embodiment, a scan or image capture of the user may be used to create an avatar.

In one embodiment, the movement and location of the users are tracked by the servers in the computing network. The system may synchronously allow users to communicate with their avatars both with sound and with movement within the virtual environment as shown in FIG. 9A. For example, if the first user is located in Paris, the user may point at a VR snippet and verbally comment on what they would like to preview and the second user located in Los Angeles will see and hear the Paris user point at the VR snippet and they can preview and discuss it in synchronously in the virtual environment as shown in FIG. 9B. FIG. 9C illustrates how the selected trailer completely transforms into the full experience in one embodiment of the Virtual Reality (VR) platform. The full experience (i.e., the full clip or movie) is presented in front of the users in life-sized form. Each of the users may interact with the VR experience as known and developed in the art.

In this embodiment, any haptic interface devices may also give the user the sensation of another user on the VR platform. For example, the haptic device will provide feedback (e.g., resistance, vibration, lights, sound, or the like) to the user when the haptic device is determined by the system to be located at a physical, spatial location relative to an avatar or other virtual object on the VR platform.

FIGS. 8A-8C illustrate how the user can select a VR snippet and interact with the VR snippet. As shown in FIG. 8A, the user 150 points the controller at a VR snippet entitled “Location”. In other embodiments, the user may use voice commands or gaze to select the snippet. For example, the user may select the “Location” VR snippet by looking at for a predetermine period of time ranging from 1-15 seconds. In alternate embodiments, the VR system may deduce the VR snippet being selected by the user system calculating the head position or pupil tracking (via the VR headset). As those skilled in the art will appreciate, one or more of these functions may be utilized by the user and system to select a VR snippet.

Once the VR snippet is selected, the VR platform may automatically play the fully-dimensionalized trailer. In an alternate embodiment, the user will need to take a positive action to play the trailer (e.g., voice command, gaze for predetermined period of time, or user input via controller, or any combination thereof). The user may also obtain or ask for information about the VR snippet.

FIG. 8B illustrates how the selected trailer begins to transform into the full experience in one embodiment of the Virtual Reality (VR) platform. That is, the user can elect to launch the full VR experience after the VR trailer is presented. The user may launch (or play) the full VR experience by user input such as, but not limited to, gaze, controller input, or voice commands. For example, the voice commands may be terms such as “play,” “launch,” “start,” “buy,” “go back” or “stream.” These commands may be uttered by the user in multiple languages. The system will have the necessary software to translate any foreign language commands.

FIG. 8C illustrates how the selected trailer completely transforms into the full experience in one embodiment of the Virtual Reality (VR) platform. The full experience (i.e., the full clip or movie) is presented in front of the user in life-sized form. The user may interact with the VR experience as known and developed in the art.

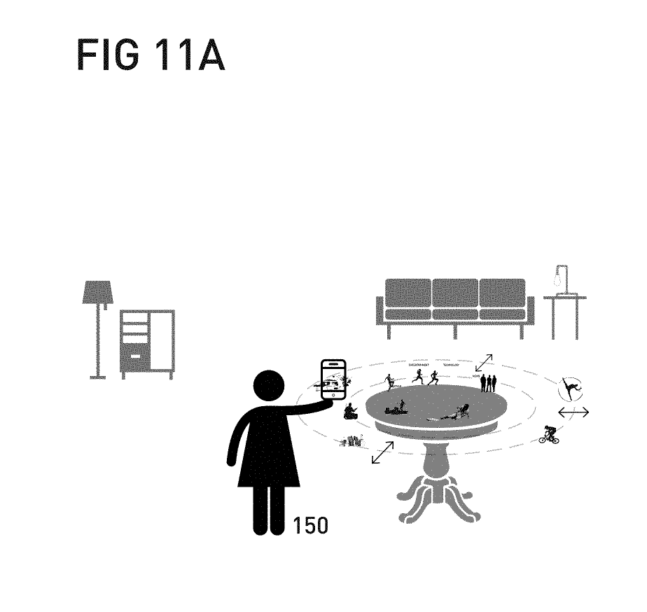

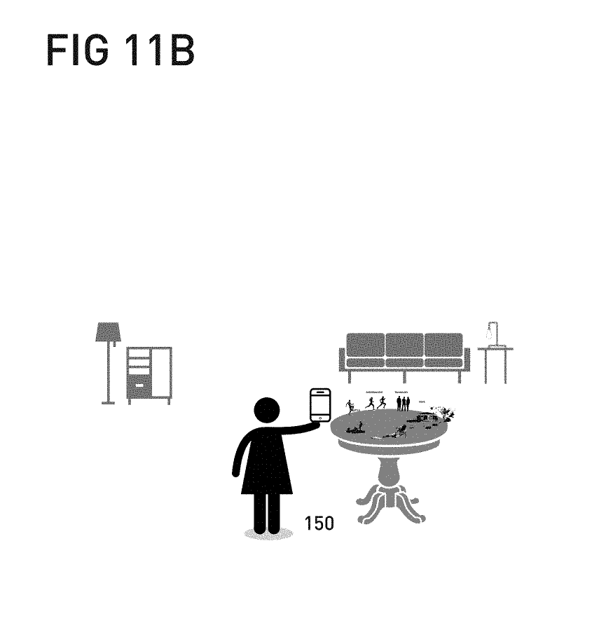

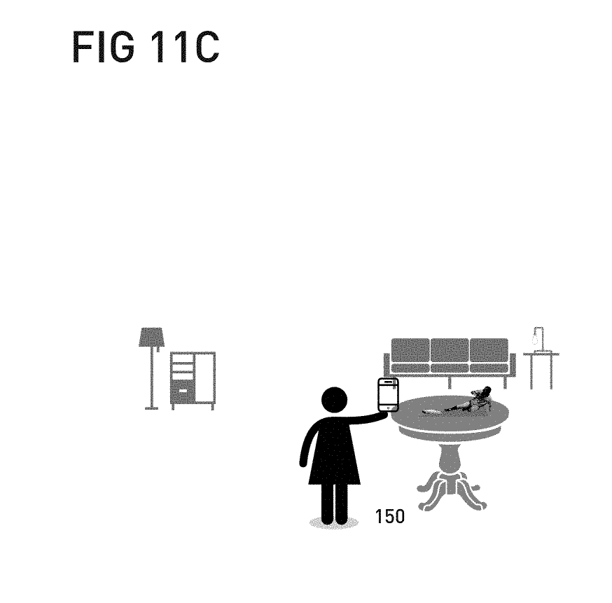

FIG. 11A illustrates one embodiment of the Augmented Reality (AR) platform showing the user experience (UX) of the platform in which the AR snippets/trailers can placed on a tabletop or other object prior to being streamed in full by user with their AR-enabled device or head mounted display. Various content verticals such as but not limited to can include news, entertainment, sports, lifestyle and technology populate each concentric circle. The circles spread outward instead of upward but offering users the ability to transform circles of content until they find one of interest.

FIG. 11B illustrates one embodiment of the Augmented Reality (AR) platform projected onto a tabletop or object and showing the UX when the user chooses a circle of AR snippets/trailers of interest. The user is able to interact with the AR content in these embodiments similar to the VR content as disclosed above. More specifically, the user may use an input controller, voice commands, or the mobile computing device to select AR content. In some embodiment, the user may be able to use gaze functions on AR-enabled mobile devices.

FIG. 11C illustrates one embodiment of the Augmented Reality (AR) platform placed on a tabletop or object showing the UX of the platform when the user launches a specific piece of content.

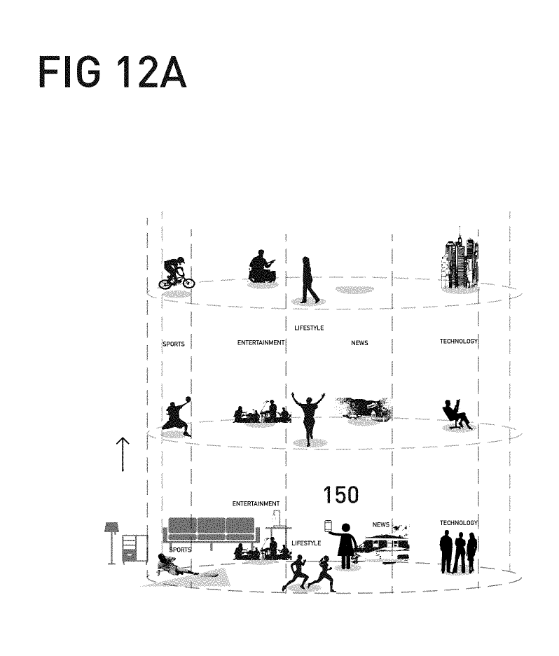

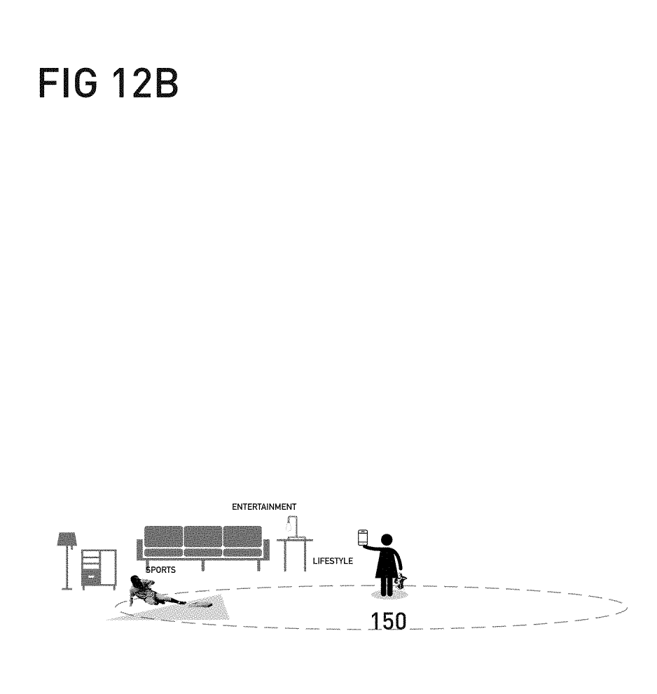

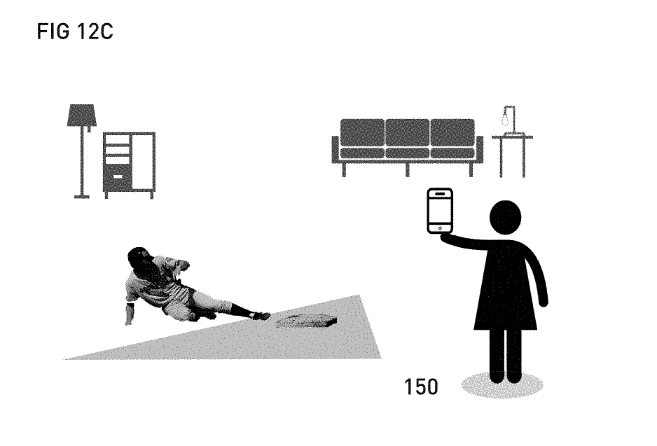

FIG. 12A illustrates a one embodiment of the Augmented Reality (AR) platform showing the UX of the platform in which the AR snippets/trailers can placed on the ground. The AR snippets can be viewed in lifesized form with AR-enabled device or a head mounted display. Various content verticals such as but not limited to can include news, entertainment, sports, lifestyle and technology populate each concentric circle. The circles spread upward but not downward offering users the ability to slide circles of content downward. The AR snippets at the bottom circles would disappear below the visible physical world floor.

FIG. 12B illustrates a one embodiment of the Augmented Reality (AR) platform is presented on the ground. When the user selected a particular AR snippet, the AR snippet or trailer is shown on the ground. In other embodiments, the AR snippets may be projected or presented on any surface in the physical world.

FIG. 12C illustrates a one embodiment of the Augmented Reality (AR) platform placed on a ground showing the UX of the platform when the user launches and streams a specific piece of content.

As those skilled in the art will appreciate, the VR system includes both hardware and software. The hardware includes a computer that controls the various sensory display devices (e.g., head-mounted displays for presenting 3D visual content and headphones for 3D audio content). The computer includes a processor and memory to execute software to create the virtual environment. The computer may also include a dedicated graphics card and dedicated sound cards. The VR system includes at least one tracking device in communication with the computer to track the location of the user's head and any other body parts. The VR system also includes input devices that allow the user to interact and/or manipulate content in the virtual environment including, but not limited to, a keyboard, voice recognition device (microphone), instrumented glove, controllers, mice, joysticks, wands, or other input devices. A network links servers and user devices, and can be mobile or wired. User devices can communicate either directly with the server network, or locally with other user devices through a special gateway.

In a representative VR system, the system incorporates a network of connected computer servers. each server comprising processors, memory, one or more servers connected through one or more high bandwidth interfaces. The servers in the computing network need not be co-located. The one or more servers each comprise one or more processors for executing program instructions. The servers also include memory for storing the program instructions and data that is used and/or generated by processes being carried out by the servers under direction of the program instructions. The servers also include memory, storage, processors, and specialized processors for rendering and generating graphics, images, video, audio and multi-media files. Software running on the servers and/or devices and/or gateways generates digital virtual environments with which users can interact. These environments can be populated with digital virtual objects that appear physically present to the user. The software incorporates all the data necessary to determine the appearance of said environments and objects, and all the ways in which users may interact with them. These data sets include, but are not limited to, the physical and geometric dimensions and appearance of an environment, whether captured via photography (photogrammetry) or computer generated (CG) or any other method yet to be developed; human figures and their actions, whether captured via volumetric video capture (videogrammetry); motion capture of actual individuals; computer generated (CG) or captured by any other method yet to be developed; and other data pertaining to atmospheric and weather conditions, terrain, and temperature. Additional data sets define and determine the ways in which the virtual digital environment operates, including physical rules, spatial relationships, and temporal rules.

Virtual digital objects can be animate or inanimate and include, but are not limited to, buildings, plants, vehicles, people, animals, creatures, machines, data displays, 2D video, 360° video, text, and images. The virtual environment also comprises rules defining and controlling the behavior of digital objects placed in that environment, as well as information about objects, behaviors and conditions actually present in the physical world. The data that describes or defines the object, or that stores its current state, is generally referred to herein as object data. This data is processed by the servers or, depending on the implementation, by a gateway or user device, to generate an instance of the object and render the object in an appropriate manner for the user to experience through a user device.

In some embodiments, the system includes a gateway. The gateway provides local connection to the computing network for one or more users. In some embodiments, it may be implemented by a downloadable software application that runs on the user device or another local device. In other embodiments, it may be implemented by a hardware component (with appropriate software/firmware stored on the component, the component having a processor) that is either in communication with, but not incorporated with or attracted to, the user device, or incorporated with the user device. The gateway communicates with the computing network via the data network, and provides data exchange between the computing network and one or more local user devices. The gateway component may include software, firmware, memory, and processing circuitry, and may be capable of processing data communicated between the network and one or more local user devices.

The software includes computer-readable code on a computer-readable medium to create the VR platform and VR environment. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a blue-ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

The foregoing description, for purposes of explanation, uses specific nomenclature and formula to provide a thorough understanding of the disclosure. It should be apparent to those of skill in the art that the specific details are not required in order to practice the disclosure. The embodiments have been chosen and described to best explain the principles of the disclosure and its practical application, thereby enabling others of skill in the art to utilize the disclosure, and various embodiments with various modifications as are suited to the particular use contemplated. Thus, the foregoing disclosure is not intended to be exhaustive or to limit the disclosure to the precise forms disclosed, and those of skill in the art recognize that many modifications and variations are possible in view of the above teachings.

One of ordinary skill in the art will appreciate that not all virtual reality devices will have all these components and may have other components in addition to, or in lieu of, those components mentioned here. Furthermore, while these components are viewed and described separately, various components may be integrated into a single unit in some embodiments.

1. A system for providing a virtual reality interface, the system comprising:
a backend network comprising a server in communication with one or more database and a storage system housing virtual reality media content, wherein the backend network presents a virtual reality platform populated with previews of virtual reality content, wherein each preview is presented in a fully-dimensionalized form;
a user virtual reality system in communication with the backend network, wherein the user virtual reality system includes virtual reality device that presents the virtual reality platform to the user in a fully-dimensionalized form, and wherein the virtual reality device allows the user to browse, search, and play a preview of the virtual reality content;
a web portal in communication with the backend network, wherein the web portal permits a developer to upload virtual reality content to the storage system; and
a software component downloaded to a computer of the developer, wherein the software component obtains the preview from the developer computer to be used on the virtual reality platform.

2. The system of claim 1, wherein the software component automatically creates the preview from at least the full-length virtual reality content, wherein the virtual reality preview is presented on the virtual reality platform.

3. The system of claim 1, wherein the virtual media platform further presents three-dimensional icons of the virtual reality content.

4. The system of claim 1, wherein the three-dimensional icons are presented in a three-dimensional ring around the user, wherein the user is the center of the three-dimensional ring.

5. The system of claim 1, wherein the user virtual reality system is configured to allow the virtual reality content to be searched by voice commands, user gaze, or user input via a user control device.

6. The system of claim 1, wherein the virtual reality platform is networked so that two or more users can select and watch virtual reality content together.

7. The system of claim 1, wherein the virtual reality content is presented to the user as a life-size, volumetric experience.

8. A system for providing an augmented reality interface, comprising:
a user device for presenting an augmented reality interface presented in the user environment, wherein the augmented reality interface is populated with augmented reality content, wherein the interface allows the user to browse, search, and play a preview of the augmented reality content; and
a backend network comprising a server in communication with one or more databases and a storage system housing augmented reality content, wherein the backend network is in communication with the user device.

9. The system of claim 8, wherein augmented reality content is represented by augmented reality icons that are presented in the user environment in concentric rings.

10. The system of claim 8, wherein augmented reality content is searchable by voice commands, user gaze, or user input via a user input device.

11. The system of claim 8, wherein the augmented reality content is displayed as life-size, volumetric experience.

12. A system for providing a virtual reality interface, the system comprising:
a backend network comprising a server in communication with one or more database and a storage system housing virtual reality media content, wherein the backend network presents a virtual reality platform populated with previews of virtual reality content, wherein each preview is presented in a fully-dimensionalized form;
a user virtual reality system in communication with the backend network, wherein the user virtual reality system includes virtual reality device that presents the virtual reality platform to the user in a fully-dimensionalized form, and wherein the virtual reality device allows the user to browse, search, and play a preview of the virtual reality content; and
a software component downloaded to a computer of the developer, wherein the software component obtains the preview from the developer computer to be used on the virtual reality platform.

13. The system of claim 12, further comprising a web portal in communication with the backend network, wherein the web portal permits a developer to upload virtual reality content to the storage system.

14. The system of claim 12, wherein the software component automatically creates the preview from at least the full-length virtual reality content, wherein the virtual reality preview is presented on the virtual reality platform.

15. The system of claim 12, wherein the virtual media platform further presents three-dimensional icons of the virtual reality content.

16. The system of claim 12, wherein the user virtual reality system is configured to allow the virtual reality content to be searched by voice commands, user gaze, or user input via a user control device.

17. The system of claim 12, wherein the virtual reality platform is networked so that two or more users can select and watch virtual reality content together.
